(19) United States
(12) Patent Application Publication
(10) Pub. No.: US 2018/0360255 A1
(43) Pub. Date: Dec. 20, 2018

(54) Brewing Capsule Structure

(71) Applicant: Doctor T Company Ltd., London (GB)

(72) Inventors: Zhong-Guang Ye, Shanghai (CN); Jui-Teng Liu, Changhua City (TW)

(21) Appl. No.: 15/622,144

(22) Filed: Jun. 14, 2017

(51) Int. Cl. A47J 31/06; A47J 31/36

(52) U.S. Cl. CPC A47J 31/0642; A47J 31/4407; A47J 31/3628

(57) ABSTRACT

A brewing capsule structure contains: a case, a holder, a filtration material, and a sealing element. The case includes a surround part defined on a peripheral wall thereof, and the case also includes a closing part fixed on a first end of the surround part, the surround part has an orifice defined on a second end thereof, and the case further includes a chamber configured to accommodate a brewing material. The holder is accommodated in the chamber of the case and includes multiple mixing blades extending to the closing part of the case. The filtration material is secured on a first end of the case and located opposite to a second end of the case so as to filter the brewing material in the chamber of the case. The sealing element is configured to matingly cover the first end of the case.

### FIELD OF THE INVENTION

The present invention relates to a brewing capsule structure which is applicable for a capsule brewing machine so as to enhance extraction effect and to decrease brewing time.

### BACKGROUND OF THE INVENTION

As illustrated in FIG. 1, a conventional brewing capsule 10 for brewing tea leaves contains: a case 11 having a chamber 111 defined in the case 11, a sealing part 112 fixed on a first end of the chamber 111, an opening formed on a second end of the chamber 111, an accommodation bag 12 configured to accommodate the tea leaves and housed in the chamber 111, and a closing element 13 matingly covering the opening of the case 11.

Referring to FIGS. 2 and 3, the brewing capsule 10 mates with a capsule brewing machine 20, wherein the capsule brewing machine 20 includes a housing portion 201 having an orifice defined on a top of the housing portion 201 so as to accommodate the brewing capsule 10, a rotatable cover 202 rotatably connected on with the housing portion 201, a push element 21 fixed on a first side of the housing portion 201, an inlet tube 22 having an inlet 221, and a connection rod set 23 mounted among the push element 21, the inlet tube 22, and the rotatable cover 202. Thereby, as rotating the rotatable cover 202, the connection rod 23 drives the push element 21 and the inlet tube 22 to move horizontally and reciprocatingly. The capsule brewing machine 20 further includes a stop plate 24 which has multiple V-shaped insertions 241 arranged on a second side of the housing portion 201 and has a channels 242, and an outlet tube 25 located below the channel 242 and formed in a funnel shape. With reference to FIGS. 3 and 4, in operation, the brewing capsule 10 is accommodated in the housing portion 201 of the capsule brewing machine 20, and the rotatable cover 202 is rotated so that the connection rod set 23 drives the push element 21 and the inlet tube 22 to move toward the crewing capsule 10 horizontally, the push element 21 pushes the brewing capsule 10, and the inlet tube 21 inserts through the sealing part 112 of the case 11 so that the outlet 221 of the inlet tube 21 moves into the chamber 111 of the case 11. After the brewing capsule 10 is pushed by the push element 21, the stop plate 24 stops the brewing capsule 10 and its multiple insertions 241 insert through the closing element 13 so as to produce multiple through holes on the closing element 13. As shown in FIG. 5, hot water is fed into the chamber 111 of the case 11 from the inlet 221 of the inlet tube 22 so as to soak the tea leaves in the accommodation bag 12 for a predetermined time, thus extracting tea water. Referring further to FIG. 6, the hot water is fed into the chamber 111 of the case 11 from the inlet 221 of the inlet tube 22 again so as to mix with the tea water extracted in the chamber 111, and the tea water is pressed and flows out of the outlet tube 25 from the multiple insertions 241 of the stop plate 24 via the through holes of the closing element 13 and the channel 242. However, the brewing capsule 10 has defects as follows:

1. When the hot water is fed into the chamber 111 from the inlet 221 of the inlet tube 21, it flows slowly and cannot stir the accommodation bag 12, thus obtaining poor extraction effect to the tea leaves.

2. The tea leaves are accommodated by the accommodation bag 12, so they are limited by the accommodation bag 12 and cannot be stirred by the hot water, thus brewing the tea leaves slowly.

The present invention has arisen to mitigate and/or obviate the afore-described disadvantages.

### SUMMARY OF THE INVENTION

The primary objective of the present invention is to provide a brewing capsule structure which stirs the brewing materially completely by using the multiple mixing blades so as to enhance extraction effect.

Another objective of the present invention is to provide a brewing capsule structure which decreases brewing time by using the multiple mixing blades.

To obtain above-mentioned objectives, a brewing capsule structure provided by the present invention contains: a case, a holder, a filtration material, and a sealing element.

The case includes a surround part defined on a peripheral wall thereof and the case also includes a closing part fixed on a first end of the surround part, the surround part has an orifice defined on a second end thereof and the case further includes a chamber configured to accommodate a brewing material. The holder is accommodated in the chamber of the case and includes multiple mixing blades extending to the closing part of the case. The filtration material is secured on a first end of the case and located opposite to a second end of the case so as to filter the brewing material in the chamber of the case. The sealing element is configured to matingly cover the first end of the case.

### BRIEF DESCRIPTION OF THE DRAWINGS

FIG. 1 is a cross sectional view of a conventional brewing capsule.

FIG. 2 is a perspective view showing the operation of the conventional brewing capsule and a conventional capsule brewing machine.

FIGS. 3 to 6 is a cross sectional view showing the operation of the conventional brewing capsule and the conventional capsule brewing machine.

FIG. 7 is a perspective view showing the exploded components of a capsule brewing structure according to a preferred embodiment of the present invention.

FIG. 8 is a perspective view showing the assembly of the capsule brewing structure according to the preferred embodiment of the present invention.

FIG. 9 is a cross sectional view showing the assembly of the capsule brewing structure according to the preferred embodiment of the present invention.

FIG. 10 is a cross sectional view taken along the line A-A of FIG. 9.

FIG. 11 is a perspective view showing the operation of the brewing capsule and a capsule brewing machine according to the preferred embodiment of the present invention.

FIGS. 12 to 16 is a cross sectional view showing the operation of the brewing capsule structure and the capsule brewing machine according to the preferred embodiment of the present invention.

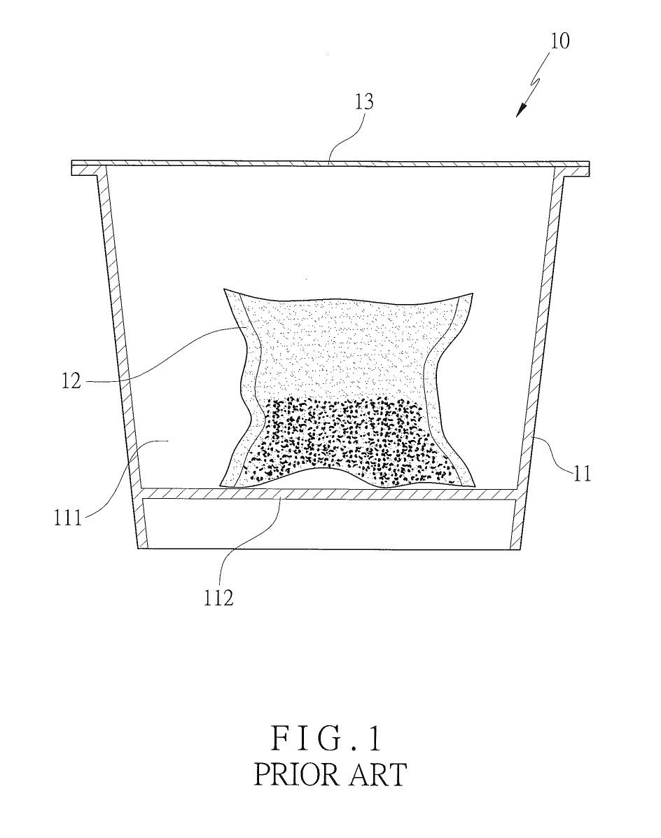

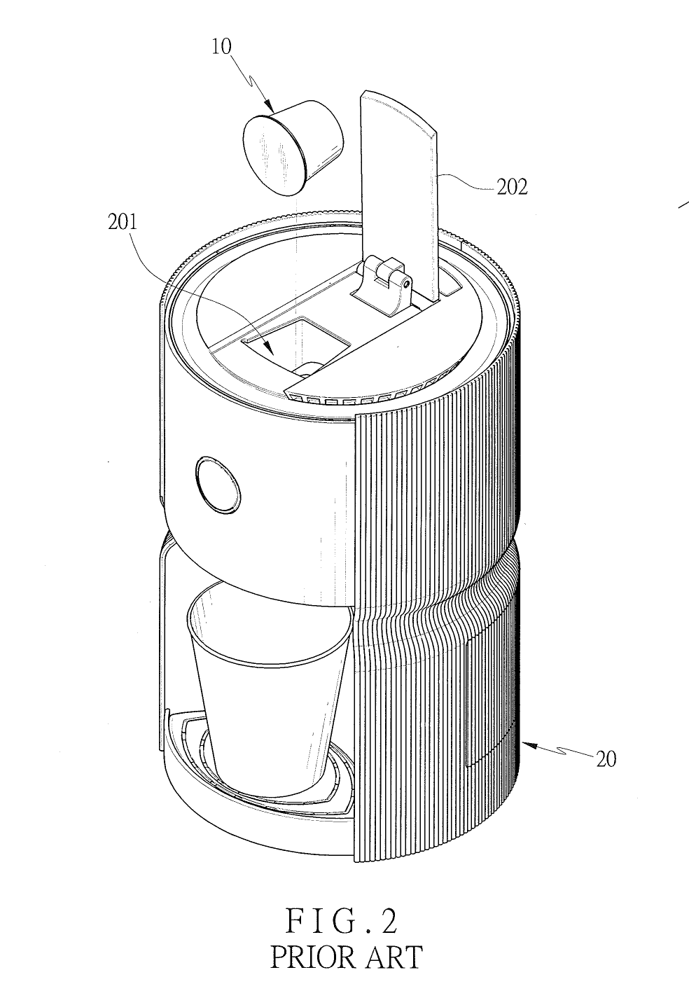

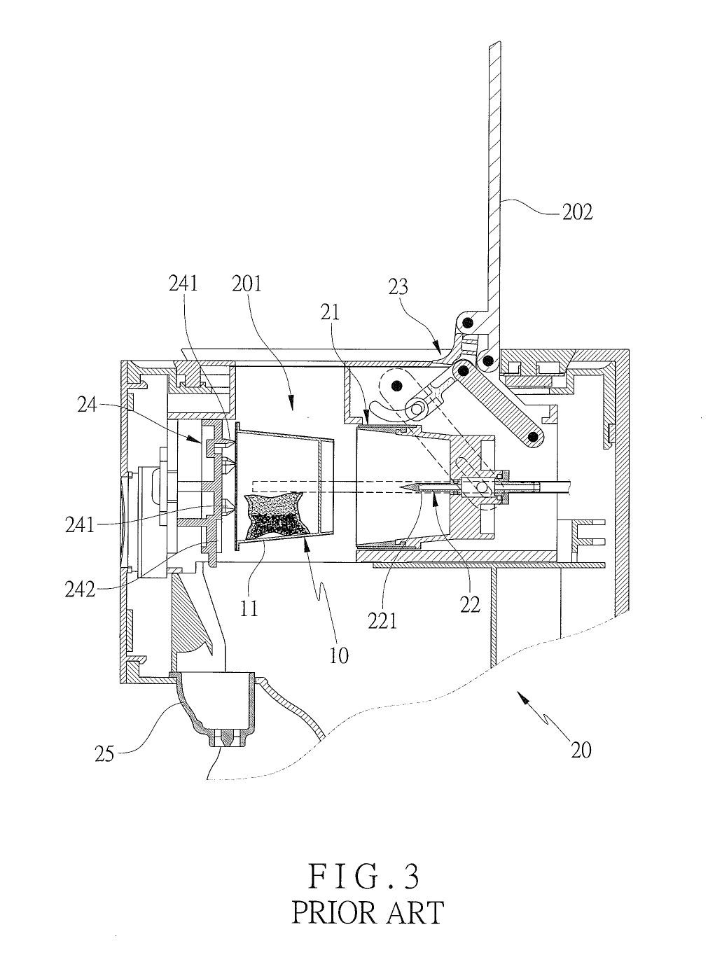

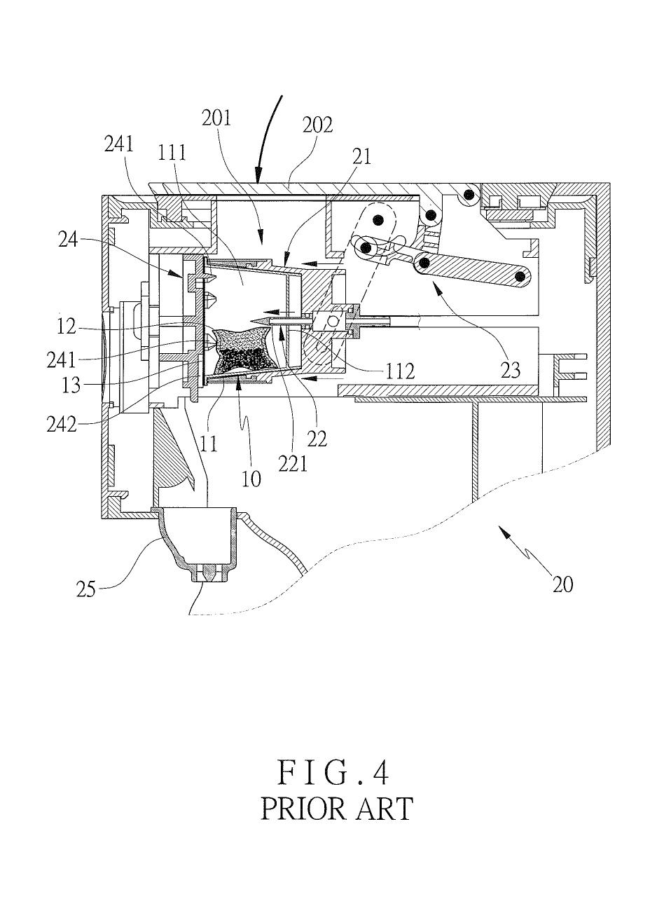

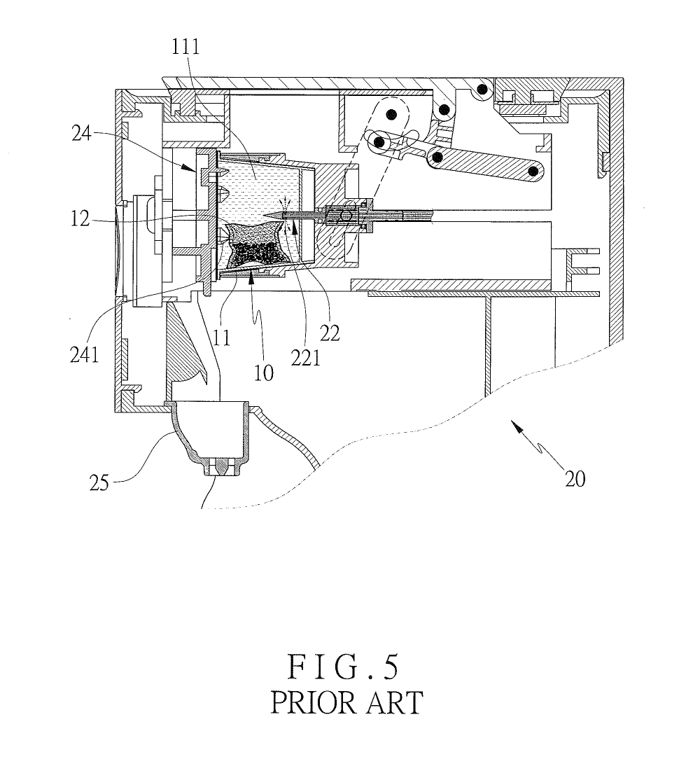

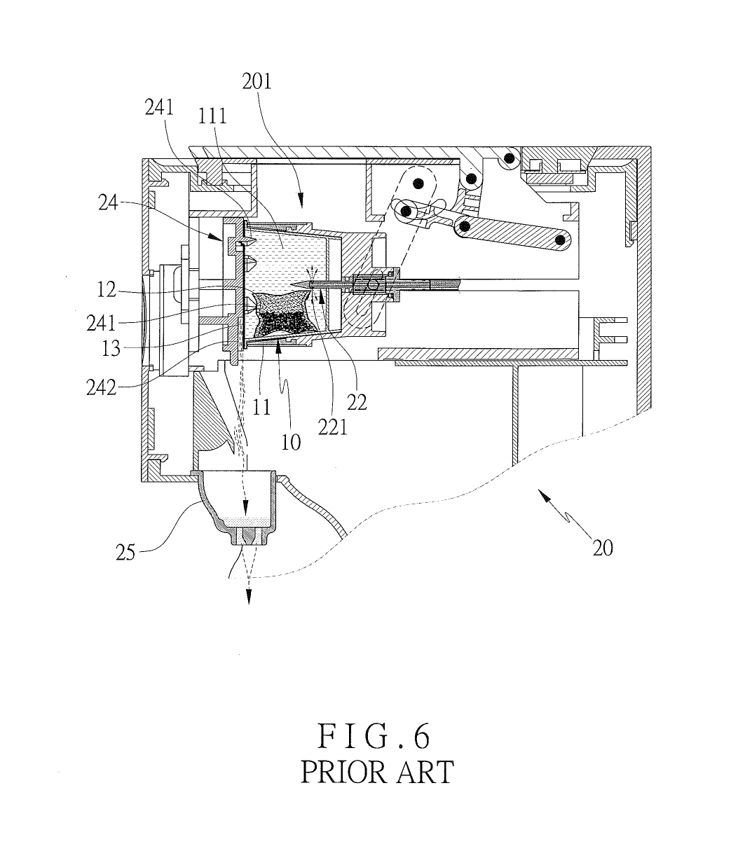

### DETAILED DESCRIPTION OF THE PREFERRED EMBODIMENTS

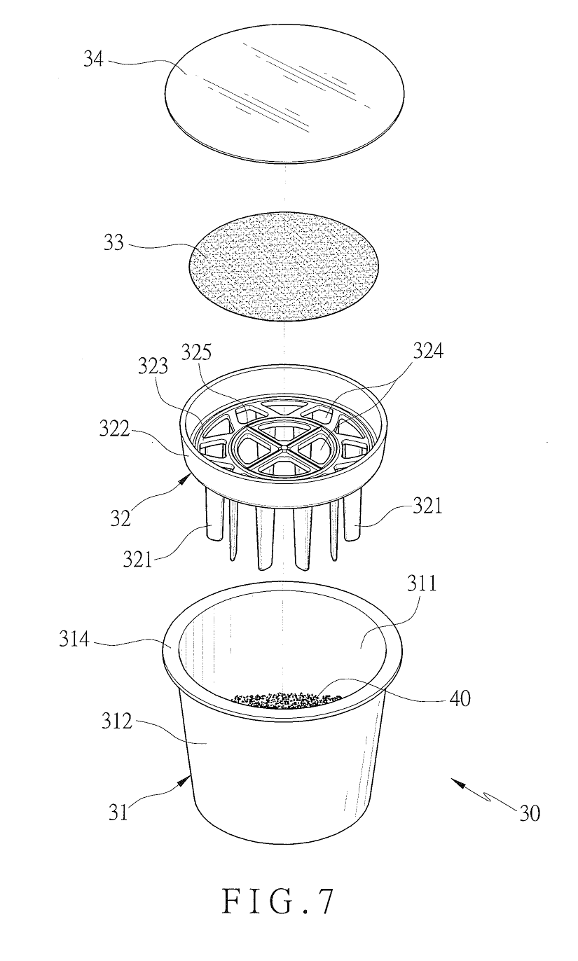

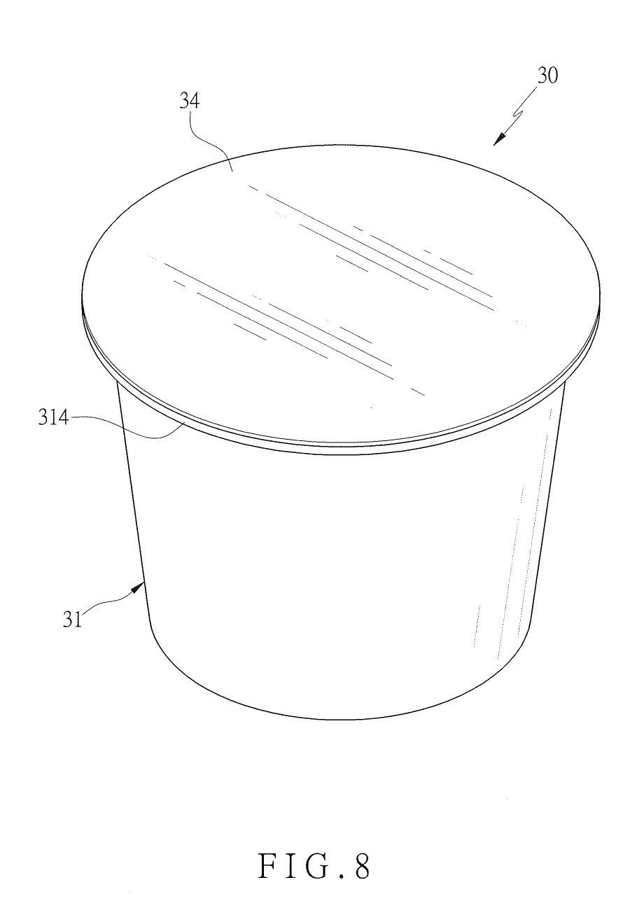

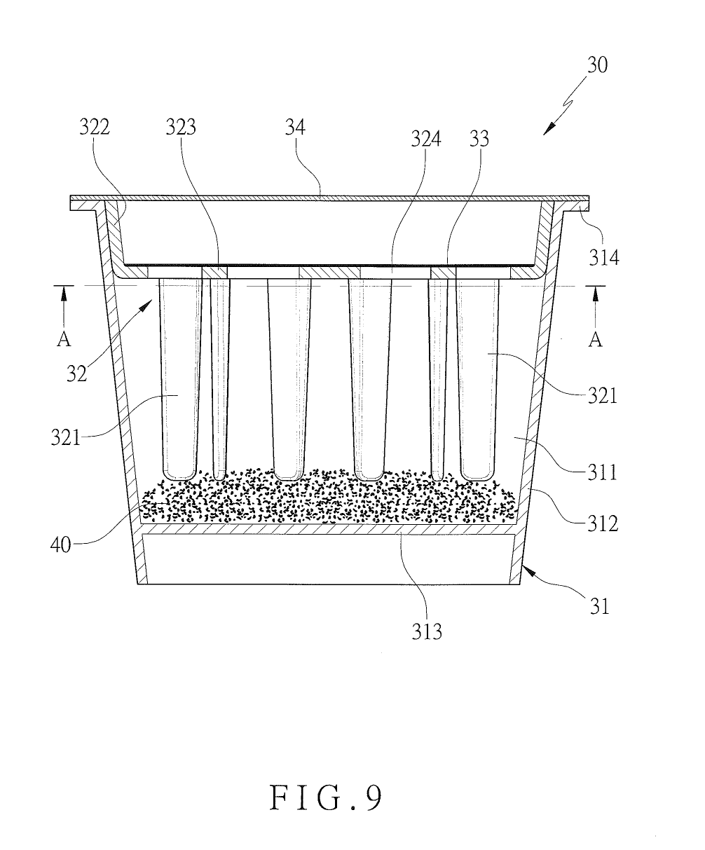

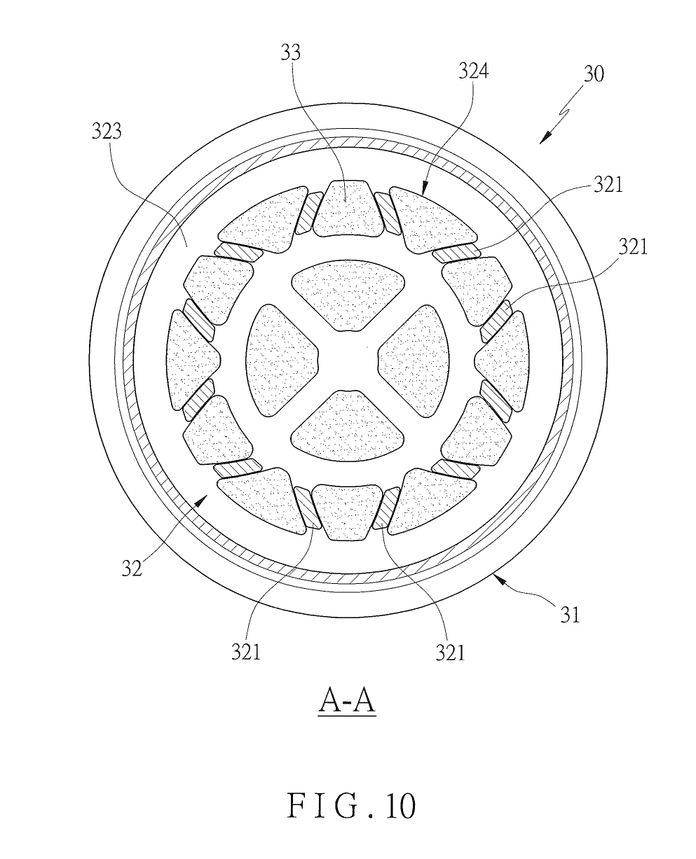

With reference to FIGS. 7-10, a brewing capsule 30 according to a preferred embodiment of the present invention comprises: a case 31, a holder 32, a filtration material 33, and a sealing element 34. The case 31 includes a surround part 312 defined on a peripheral wall thereof and formed in a cylinder shape, and the case 31 includes a closing part 313 fixed on a first end of the surround part 312, wherein the surround part 312 has an orifice defined on a second end thereof. The case 31 also includes a chamber 311 configured to accommodate a brewing material 40 which is tea leaves or coffee powders. The chamber 311 of the case 31 also accommodates the holder 32, and the holder 32 includes multiple mixing blades 321 extending to the closing part 313. In this embodiment, the holder 32 includes a fitting sleeve 322 configured to fit on a first end of the case 31, a connection part 323 formed on the fitting sleeve 322 and in a grid shape, and plural grooves 324 separately arranged on the connection part 323, wherein a first surface of the connection part 323 integrally connects with the multiple mixing blades 321. In this embodiment, any two of the multiple blades 321 are arranged on each of multiple aliquot positions (such as 60 degrees) of the connection part 323 at a V-shapes angle. The filtration material 33 is a porous nonwoven fabric and is secured on the first end of the case 31 so as to filter the brewing material 40 in the chamber 311 as brewing, wherein the filtration material 33 is adhered on an inner surface of the first end of the case 31 or on the holder 32. In this embodiment, the filtration material 33 is adhered on a second surface of the connection part 323, wherein the connection part 323 has plural ribs 325 arranged on the second surface thereof and welded with the filtration material 33 in a high frequency welding manner or a hot pressing mariner, hence the filtration material 33 covers the plural grooves 324 of the connection part 323 and filters the brewing material 40 in the chamber 311 as brewing. The sealing element 34 is a thin sheet so as to matingly cover the chamber 311 of the case 31. In this embodiment, a peripheral tab 314 extends outwardly from the second end of the surround part 312 of the case 31, the sealing element 34 matingly contacts with the peripheral tab 314 of the case 31 in the hot pressing manner so as to close the chamber 311 of the case 31.

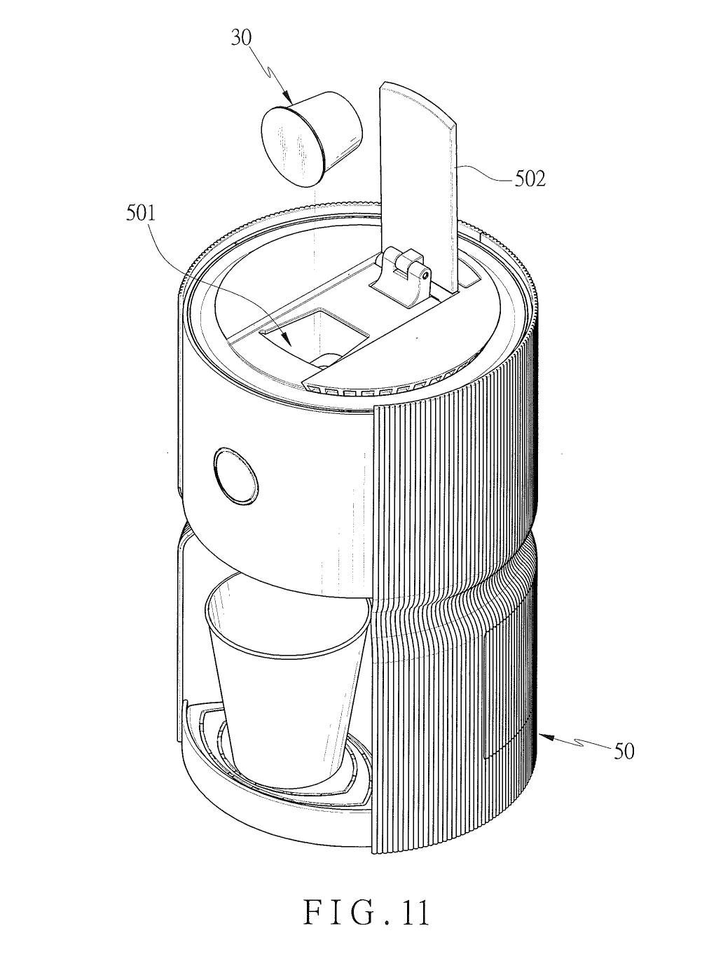

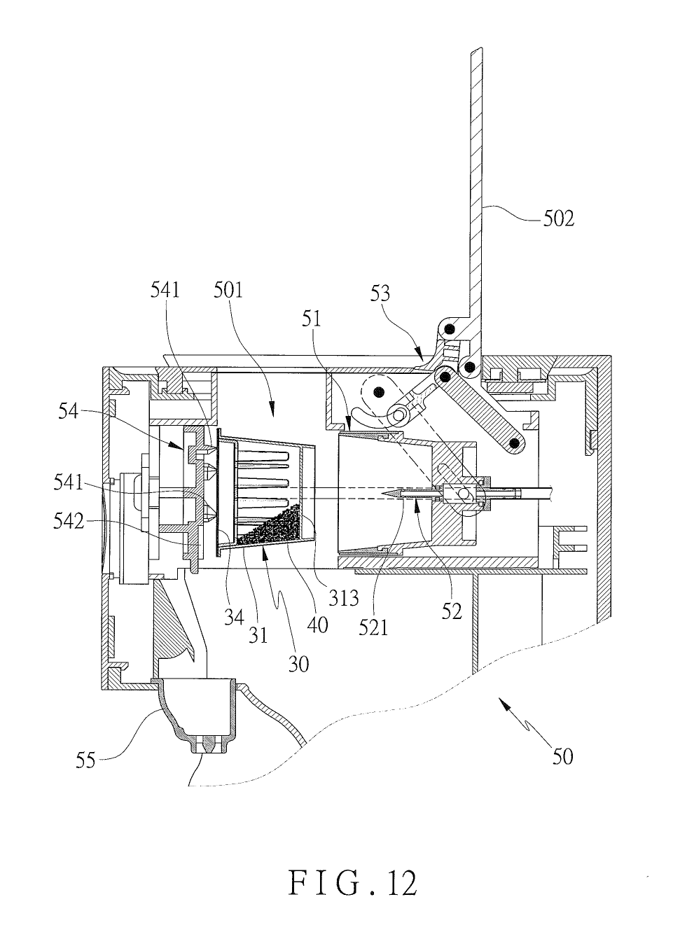

Referring to FIGS. 11 and 12, the brewing capsule 30 is housed in a capsule brewing machine 50, wherein the capsule brewing machine 50 includes a housing portion 501 defined on a top thereof and having an opening so as to house the brewing capsule 30, a rotatable cover 502 arranged on the opening of the housing portion 501, a push element 51 mounted on a first side of the housing portion 501, an inlet tube 52 located between the push element 51 and having an inlet 521, and a connection rod set 53 defined among the push element 51, the inlet tube 52, and the rotatable cover 502 so that when the rotatable cover 502 is rotated, the connection rod set 53 drives the push element 51 and the inlet tube 52 to move horizontally and reciprocatingly. The capsule brewing machine 50 further includes multiple V-shaped insertions 541 disposed on a second side of the housing portion 502, a stop plate 54 having a channel 542, and an outlet tube 55 located below the channel 542 and formed in a funnel shape.

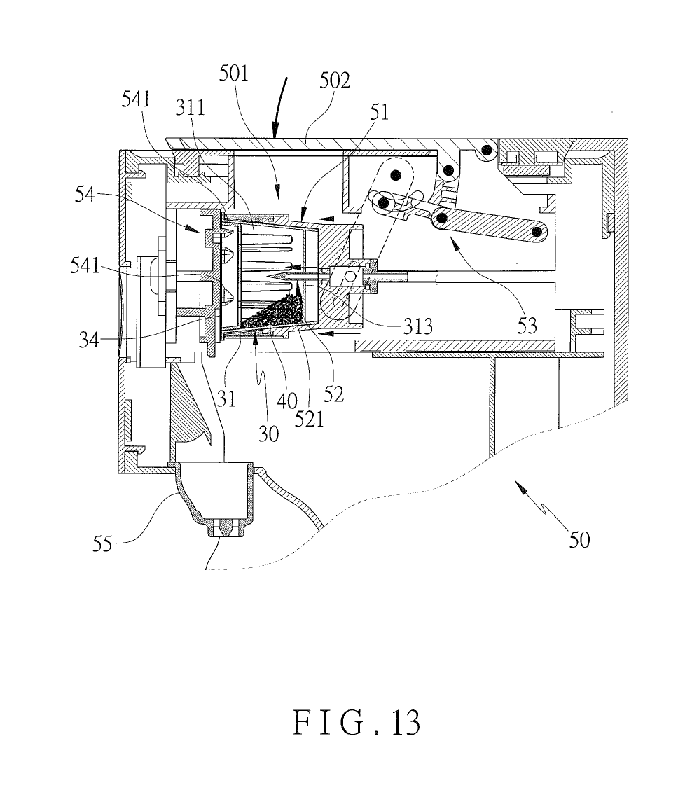

As shown in FIGS. 12 and 13, in operation, the brewing capsule 30 is accommodated in the housing portion 501 of the capsule brewing machine 50, and the rotatable cover 502 is rotated so that the connection rod set 53 drives the push element 51 and the inlet tube 52 to horizontally move toward the brewing capsule 30, the push element 51 pushes the brewing capsule 30, and the inlet tube 52 inserts into the closing part 313 of a second end of the case 31 of the brewing capsule 30,

hence the inlet 521 of the inlet tube 52 enters into the chamber 311 of the case 31, and when the brewing capsule 30 is pushed by the push element 51, the stop plate 54 stops the first end of the case 31 of the brewing capsule 30, and the multiple V-shaped insertions 541 insert through the sealing element 34 so as to produce plural through holes on the sealing element 34.

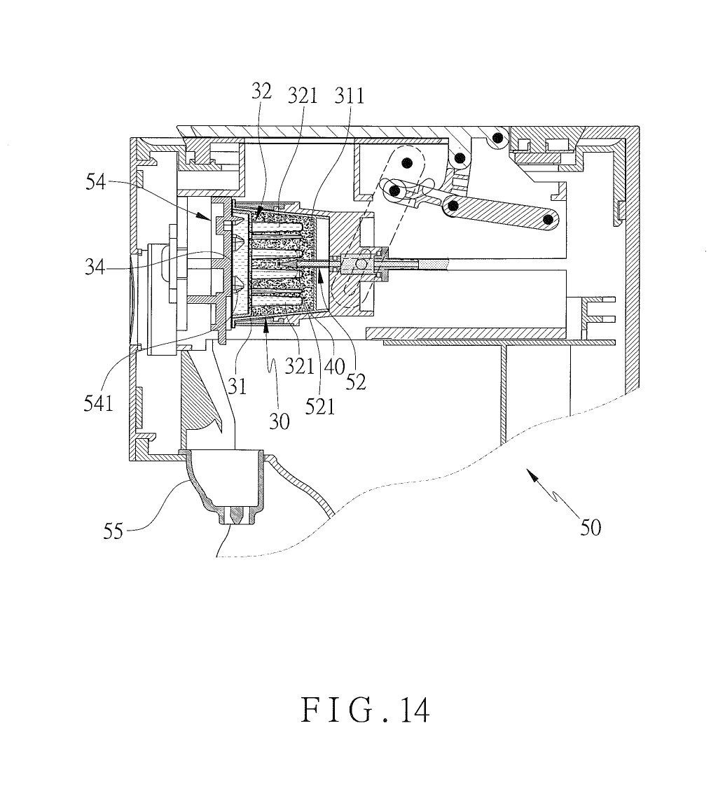

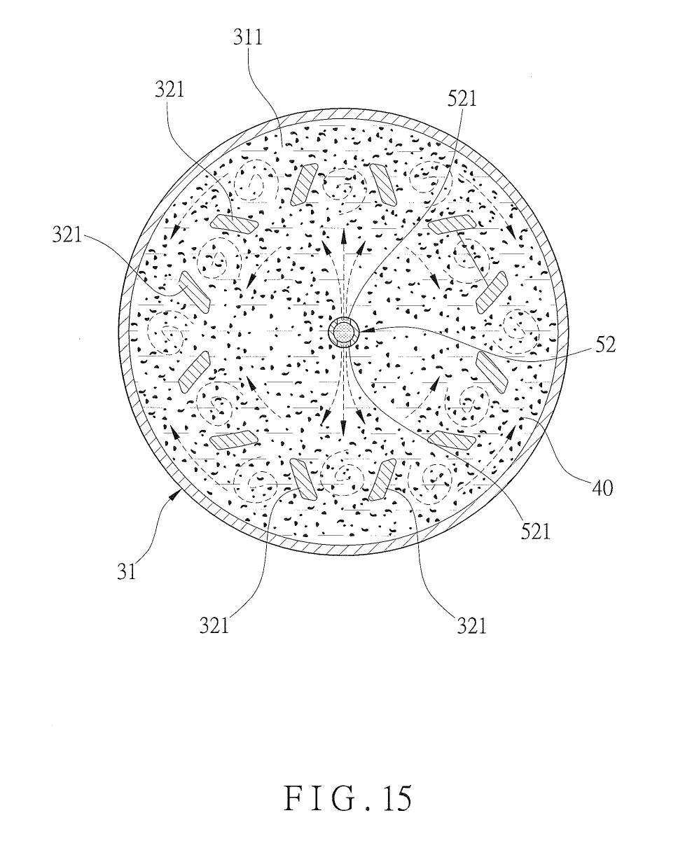

As illustrated in FIGS. 14 and 15, after hot water is filled into the chamber 311 of the case 31 from the inlet 521 of the inlet tube 52, the brewing material 40 is soaked in the hot water for a predetermined time so as to extract tea water. When the hot water is filled into the chamber 311 of the case 31 from the inlet 521 of the inlet tube 52, the hot water sprays and pushes the multiple mixing blades 321 of the holder 32. Since any two mixing blades 321 are arranged on each aliquot position in the V-shapes angle, the hot water in the chamber 311 is stirred by the multiple mixing blades 321 of the holder 32 so as to soak the brewing material 40 completely in the chamber 311, thus extracting the tea water from the brewing material 40.

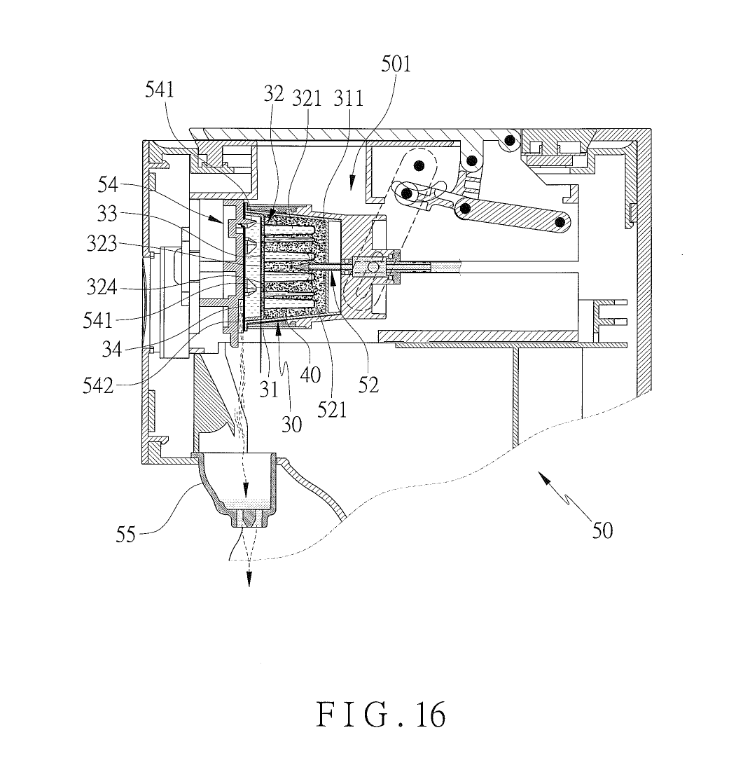

With reference to FIG. 16, the hot water is fed into the chamber 311 of the case 31 again from the inlet 521 of the inlet tube 52 so as to increase a pressure in the chamber 311 of the case 31, hence the tea water flows through the plural grooves 324 of the connection part 323 of the holder 32 and is filtered by the filtration material 33. Due to the filtration material 33 is adhered on the holder 32 of the case 31, the brewing material 40 is not housed in a tea bag and is stirred in the chamber 311 effectively. Thereafter, the tea water flows out of the outlet tube 55 from the multiple V-shaped insertions 541 of the stop plate 54 via the plural through holes on the sealing element 34 and the channel 542. Thereby, the hot water in the chamber 311 is stirred by the multiple mixing blades 321 of the holder 32 so as to soak and stir the brewing material 40 completely in the chamber 311, thus extracting the tea water from the brewing material 40 quickly.

While the preferred embodiments of the invention have been set forth for the purpose of disclosure, modifications of the disclosed embodiments of the invention as well as other embodiments thereof may occur to those skilled in the art. Accordingly, the appended claims are intended to covering assembly all embodiments which do not depart from the spirit and scope of the invention.

What is claimed is:

1. A brewing capsule structure comprising:
a case including a surround part defined on a peripheral wall of the case, and the case also including a closing part fixed on a first end of the surround part, the surround part having an orifice defined on a second end of the surround part, and the case further including a chamber configured to accommodate a brewing material;
a holder accommodated in the chamber of the case, and the holder including multiple mixing blades extending to the closing part of the case;
a filtration material secured on a first end of the case and located opposite to a second end of the case so as to filter the brewing material in the chamber of the case; and
a sealing element configured to matingly cover the first end of the case.

2. The brewing capsule structure as claimed in claim 1, wherein the holder includes a fitting sleeve configured to fit on the first end of the case.

3. The brewing capsule structure as claimed in claim 2, wherein the holder includes a connection part formed on the fitting sleeve and in a grid shape, and the holder includes plural grooves separately arranged on the connection part, wherein a first surface of the connection part integrally connects with the multiple mixing blades.

4. The brewing capsule structure as claimed in claim 3, wherein any two of the multiple blades are arranged on each of multiple aliquot positions of the connection part at a V-shapes angle.

5. The brewing capsule structure as claimed in claim 3, wherein the filtration material is adhered on an inner surface of the first end of the case or on the holder.

6. The brewing capsule structure as claimed in claim 5, wherein the filtration material is adhered on a second surface of the connection part, wherein the connection part has plural ribs arranged on the second surface thereof and welded with the filtration material in a high frequency welding manner or a hot pressing manner, hence the filtration material covers the plural grooves of the connection part and filters the brewing material.

7. The brewing capsule structure as claimed in claim 1, wherein a peripheral tab extends outwardly from the second end of the surround part of the case, the sealing element matingly contacts with the peripheral tab of the case in the hot pressing manner so as to close the first end of the case.
